(19) United States
(12) Patent Application Publication
(10) Pub. No.: US 2011/0098882 A1
(43) Pub. Date: Apr. 28, 2011

(54) Vehicle speed estimation device, method and device for detecting decreased tire pressure using the same

(75) Inventors: Toshifumi Sugisawa, Akashi-Shi (JP); Minao Yanase, Kobe-shi (JP)

(73) Assignee: Sumitomo Rubber Industries, Ltd., Kobe-shi (JP)

(21) Appl. No.: 11/244,365

(22) Filed: Oct. 6, 2005

(30) Foreign Application Priority Data
Oct. 7, 2004 (JP) 2004-294967

(51) Int. Cl. G01M 17/02; G01M 17/00

(52) U.S. Cl. 701/35; 701/29

(57) ABSTRACT

The present invention provides a vehicle-speed estimation device capable of obtaining vehicle speed with high accuracy, thereby simultaneously detecting decrease of air pressure in all wheels by using the vehicle speed. The vehicle-speed estimation device includes means for detecting lateral acceleration of a vehicle, means for detecting a yaw rate of the vehicle, means for detecting a roll angle of the vehicle, and speed estimation and calculation means for estimating vehicle speed from the lateral acceleration, yaw rate and roll angle. Alternatively, the device includes means for detecting lateral acceleration of a vehicle, means for detecting a yaw rate of the vehicle, and speed estimation and calculation means for estimating vehicle speed from the lateral acceleration and the yaw rate. A method for detecting decreased tire pressure includes a step of comparing an estimated vehicle speed with vehicle speed calculated from wheel speed, and a step of determining decreased tire pressure based on a result of the comparison. Alternatively, the method determines decreased tire pressure based on a result of the comparison of a value obtained by multiplying a yaw rate by wheel speed with lateral acceleration.

### BACKGROUND OF THE INVENTION

The present invention relates to a vehicle-speed estimation device, a method and a device for detecting decreased tire pressure using the vehicle-speed estimation device. More particularly, the present invention relates to a vehicle-speed estimation device capable of obtaining vehicle speed with high accuracy, a method and a device that simultaneously detect pressure decrease in all wheels with the use of the vehicle speed, thereby widening a region where decreased tire pressure is determined and improving precision of pressure-decrease determination.

A conventional device for detecting decreased tire pressure uses a principle that since the outer diameter of a tire (the dynamic loaded radius of a tire) is reduced more than that of a tire having normal inner pressure when a tire is deflated, wheel speed (rotational angular speed) is increased as compared with other normal tires. For example, in a method for detecting decrease of inner pressure from relative difference of the wheel speeds of tires, a value obtained from following formula is used as a judging value;

DEL={(V1+V4)/2−(V2+V3)/2}/{(V1+V2+V3+V4)/4}×100(%)

(for example, see Japanese Unexamined Patent Publication No. 305011/1988). Herein, V1 to V4 are wheel speeds of a front left tire, front right tire, rear left tire and rear right tire, respectively.

A speed (vehicle speed) as a reference is necessary for detecting increase of the rotational speeds of tires. Conventionally, the speed is compared with the rotational speeds of tires whose pressure is not decreased, or a reference is set by obtaining the vehicle speed from GPS, thereby a tire having faster rotational speeds than the reference speed is determined as a tire with decreased pressure.

There is a method for determining decreased tire pressure by using a yaw rate, lateral acceleration and forward-to-rearward acceleration other than wheel speed. For example, Japanese Unexamined Patent Publication No. 148903/2004 discloses that air pressure is determined to be decreased when a yaw rate of front wheels generated due to the rotational speed difference of the front wheels is different from a yaw rate of rear wheels generated due to the rotational speed difference of the rear wheels. Furthermore, Japanese Unexamined Patent Publication No. 148910/2004 discloses that decreased tire pressure is determined by a change rate of the deviation of the yaw rate of front wheels and the yaw rate of rear wheels with the value of a yaw rate sensor relative to speed. Japanese Unexamined Patent Publication No. 12013/2002 describes a method for correcting the aforementioned judging value by lateral acceleration. Furthermore, there is also a method for not determining decreased tire pressure when behavior of a vehicle is in excessive condition such as large lateral acceleration in order to exclude fluctuation factors (Japanese Unexamined Patent Publication No. 92114/1994).

As a method for accurately detecting vehicle speed, there have been known methods of utilizing a steering angle, a forward-to-rearward acceleration and lateral acceleration (Japanese Unexamined Patent Publication No. 118559/2003), a method of calculating vehicle speed from a tangential acceleration by obtaining a slip angle from a forward-to-rearward acceleration, lateral acceleration and a yaw rate (Japanese Unexamined Patent Publication No. 175537/1998), or a method of correcting vehicle speed from acceleration and deceleration speed (Japanese Unexamined Patent Publication No. 138905/1998).

However, as far as the relative comparison of the wheel speeds on the pair of diagonal position is performed, it is impossible to detect pressure decrease in a case that air pressures of all wheels are decreased in the same manner. Furthermore, simultaneous pressure decrease in four wheels cannot be determined by the method of determining pressure decrease by using such as the yaw rate. Accordingly, there have been problems that continuous driving without knowing the decreased pressures would lead to decrease in a fuel mileage caused by the increase of rolling resistance of tires, and further, there is danger of provoking a tire burst.

Furthermore, a method of obtaining vehicle speed from GPS requires a GPS device or a car navigation system additionally.

### SUMMARY OF THE INVENTION

In view of the above-described problems, an object of the invention is to provide a vehicle-speed estimation device capable of obtaining vehicle speed with high accuracy as well as a method and a device that simultaneously detect pressure decrease in all wheels with the use of the vehicle speed, thereby widening a region where decreased tire pressure is determined and improving precision of pressure-decrease determination.

The present invention provides a vehicle-speed estimation device including: lateral acceleration detecting means for detecting lateral acceleration of a vehicle; yaw rate detecting means for detecting a yaw rate of the vehicle; roll angle detecting means for detecting a roll angle of the vehicle; and speed estimation and calculation means for estimating vehicle speed from the lateral acceleration, the yaw rate and the roll angle.

The present invention also provides a vehicle-speed estimation device including: lateral acceleration detecting means for detecting lateral acceleration of a vehicle; yaw rate detecting means for detecting a yaw rate of the vehicle; and speed estimation and calculation means for estimating vehicle speed from the lateral acceleration and the yaw rate.

The present invention also provides a program for estimating vehicle speed of a vehicle, which allows a computer to function as speed estimation and calculation means for estimating the vehicle speed from lateral acceleration, a yaw rate and a roll angle.

The present invention also provides a program for estimating vehicle speed of a vehicle, which allows a computer to function as speed estimation and calculation means for estimating the vehicle speed from lateral acceleration and a yaw rate.

The present invention also provides a method for detecting decreased tire pressure on the basis of wheel speed obtained from a tire mounted on a vehicle, the method including steps of: detecting wheel speed of each tire; storing vehicle speed calculated from the wheel speed; detecting lateral acceleration of the vehicle; detecting a yaw rate of the vehicle; detecting a roll angle of the vehicle; estimating vehicle speed from the lateral acceleration, the yaw rate and the roll angle; comparing the estimated vehicle speed with the vehicle speed calculated from the wheel speed; and determining decreased tire pressure on the basis of a result of the comparison.

The present invention also provides a method for detecting decreased tire pressure on the basis of wheel speed obtained from a tire mounted on a vehicle, the method including steps of: detecting wheel speed of each tire; storing vehicle speed calculated from the wheel speed; detecting lateral acceleration of the vehicle; detecting a yaw rate of the vehicle; estimating vehicle speed from the lateral acceleration and the yaw rate; comparing the estimated vehicle speed with the vehicle speed calculated from the wheel speed; and determining decreased tire pressure on the basis of a result of the comparison.

The present invention also provides a device for detecting decreased tire pressure on the basis of wheel speed obtained from a tire mounted on a vehicle, the device including: wheel-speed detecting means for detecting wheel speed of each tire; storage means for storing vehicle speed calculated from the wheel speed; lateral acceleration detecting means for detecting lateral acceleration of the vehicle; yaw rate detecting means for detecting a yaw rate of the vehicle; roll angle detecting means for detecting a roll angle of the vehicle; speed estimation and calculation means for estimating vehicle speed from the lateral acceleration, the yaw rate and the roll angle; comparison means for comparing the estimated vehicle speed with the vehicle speed calculated from the wheel speed; and pressure-decrease determination means for determining decreased tire pressure on the basis of a result of the comparison.

The present invention also provides a device for detecting decreased tire pressure on the basis of wheel speed obtained from a tire mounted on a vehicle, the device including: wheel-speed detecting means for detecting wheel speed of each tire; storage means for storing vehicle speed calculated from the wheel speed; lateral acceleration detecting means for detecting lateral acceleration of the vehicle; yaw rate detecting means for detecting a yaw rate of the vehicle; speed estimation and calculation means for estimating vehicle speed from the lateral acceleration and the yaw rate; comparison means for comparing the estimated vehicle speed with the vehicle speed calculated from the wheel speed; and pressure-decrease determination means for determining decreased tire pressure on the basis of a result of the comparison.

The present invention also provides a program for determining decreased tire pressure on the basis of wheel speed obtained from a tire mounted on a vehicle, the program allowing a computer to function as: storage means for storing vehicle speed calculated from the wheel speed; speed estimation and calculation means for estimating vehicle speed from lateral acceleration, a yaw rate and a roll angle; comparison means for comparing the estimated vehicle speed with the vehicle speed calculated from the wheel speed; and pressure-decrease determination means for determining decreased tire pressure on the basis of a result of the comparison.

The present invention also provides a program for determining decreased tire pressure on the basis of wheel speed obtained from a tire mounted on a vehicle, the program allowing a computer to function as: storage means for storing vehicle speed calculated from the wheel speed; speed estimation and calculation means for estimating vehicle speed from lateral acceleration and a yaw rate; comparison means for comparing the estimated vehicle speed with the vehicle speed calculated from the wheel speed; and pressure-decrease determination means for determining decreased tire pressure on the basis of a result of the comparison.

The present invention also provides a method for determining decreased tire pressure with the use of lateral acceleration sensor, a yaw rate sensor and wheel speed sensor mounted on a vehicle, the method including steps of: detecting lateral acceleration by the lateral acceleration sensor; detecting a yaw rate by the yaw rate sensor; detecting wheel speed by the wheel speed sensor; comparing a value obtained by multiplying the yaw rate by the wheel speed with the lateral acceleration; and determining decreased tire pressure on the basis of a result of the comparison.

The present invention also provides a device for determining decreased tire pressure, including: lateral acceleration sensor for detecting lateral acceleration of a vehicle; a yaw rate sensor for detecting a yaw rate of the vehicle; wheel speed sensor for detecting rotational speed of a wheel mounted on the vehicle; comparison means for comparing a value obtained by multiplying the yaw rate by the wheel speed with the lateral acceleration; and pressure-decrease determination means for determining decreased tire pressure on the basis of a result of the comparison.

The present invention also provides a program for determining decreased tire pressure mounted on a vehicle, the program allowing a computer to function as: means for inputting lateral acceleration of the vehicle from lateral acceleration sensor; means for inputting a yaw rate of the vehicle from a yaw rate sensor; means for inputting wheel speed of the vehicle from wheel speed sensor; comparison means for comparing a value obtained by multiplying the yaw rate by the wheel speed with the lateral acceleration; and pressure-decrease determination means for determining decreased tire pressure on the basis of a result of the comparison.

In the present invention, the wheel speed is defined as follows: a rotational angular speed of a wheel×a dynamic loaded radius of a tire.

A device for preventing the lateral sliding of a vehicle (also referred to such as VSC and ESP) has been recently prevailed, and the device includes a lateral acceleration sensor and a yaw rate sensor. The present invention provides a method for obtaining vehicle speed by utilizing these sensors. Furthermore, not only pressure decrease in one wheel, but also simultaneous pressure decrease in four wheels can be detected by using the obtained vehicle speed.

Referring to an example described later, when the pressures of four wheels are decreased at the same rate for a front drive car of 2400 cc to which normal tires are mounted, the pressure decrease can be determined and the pressure decrease could be alarmed to a driver. As a result, it is possible to avoid decreasing in a fuel mileage caused by the increase of rolling resistance of tires as well as the danger of provoking tire burst.

According to the present invention, vehicle speed can be obtained with high accuracy, and simultaneous pressure decrease in all wheels is detected by using the obtained vehicle speed, thereby a region where decreased tire pressure is determined can be widened and accuracy of pressure decrease determination can be improved.

### BRIEF DESCRIPTION OF THE DRAWINGS

FIG. 1 is a block diagram showing a device for detecting decreased tire pressure according to one Embodiment of the present invention;

FIG. 2 is a block diagram showing an electric configuration of the device for detecting decreased tire pressure of FIG. 1;

FIG. 3 is a flowchart related to the Embodiment;

FIG. 4 is a graph showing one example in which vehicle speed is calculated with lateral acceleration/yaw rate according to Embodiment 2;

FIG. 5 is a graph that lateral acceleration calculated from a yaw rate and a value of lateral acceleration sensor are plotted when air pressure in a tire is normal in Embodiment 2; and

FIG. 6 is a graph that lateral acceleration calculated from a yaw rate and a value of lateral acceleration sensor are plotted when air pressures in four tires are reduced by 40% in Embodiment 2.

### DETAILED DESCRIPTION

A vehicle-speed estimation device, a method and a device for detecting decreased tire pressure according to the present invention will be described below with reference to the attached drawings.

### Embodiment 1

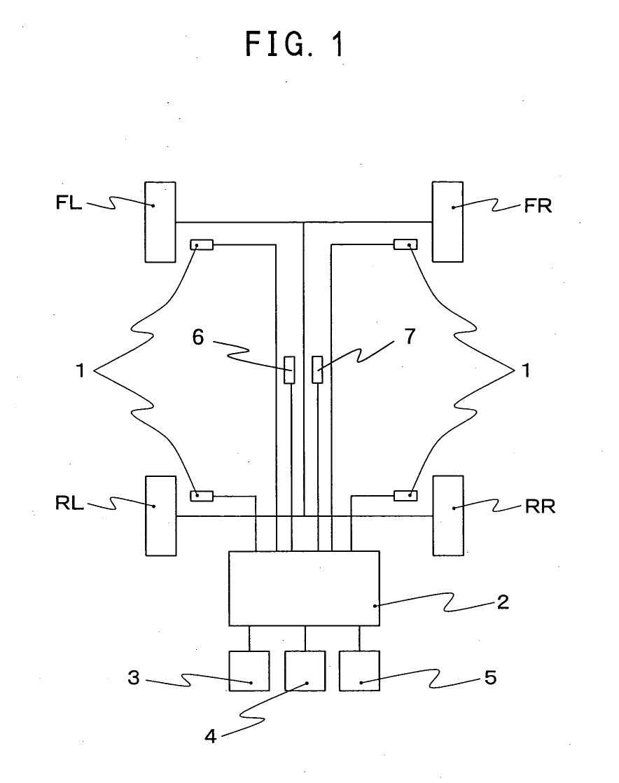

As shown in FIG. 1, the device for detecting decreased tire pressure according to Embodiment 1 of the present invention detects whether air pressures of four tires FL, FR, RL and RR provided on a vehicle are decreased or not, and includes a conventional wheel-speed detecting means 1 provided for each of tires.

As for the wheel-speed detecting means 1, there can be used a wheel speed sensor for measuring rotational angular speed and wheel speed from the numbers of pulses by generating rotational pulses using such as an electromagnetic pick-up, or an angular speed sensor in which power is generated by using rotation such as in a dynamo, wherein the rotational angular speed and wheel speed is measured from a voltage thereof. Outputs of the wheel-speed detecting means 1 are supplied to a control unit 2 which is a computer such as ABS. The control unit 2 is connected with a display 3 which is composed of a liquid crystal display element, a plasma display element or CRT for informing the decrease of air pressures, an initialization switch 4 which can be operated by a driver and an alarm 5. Furthermore, the vehicle is provided with yaw rate detecting means 6 which outputs signals corresponding to the yaw rate of the vehicle and lateral acceleration detecting means 7 which outputs signals corresponding to the acceleration to a lateral direction of the vehicle. Outputs of the yaw rate detecting means 6 and lateral acceleration detecting means 7 are supplied to the control unit 2.

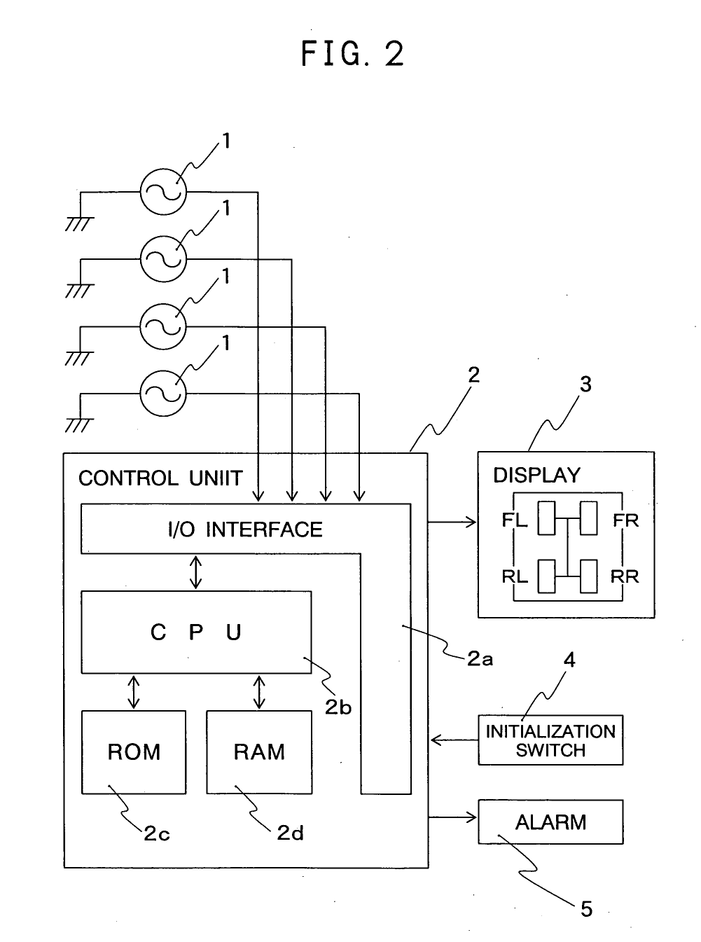

As shown in FIG. 2, the control unit 2 is composed of an I/O interface 2a which is necessary for sending/receiving signals to/from an external device, a CPU 2b which functions as the central core of arithmetic processing, a ROM 2c in which the control operation program of the CPU 2b is stored, and a RAM 2d in which data and the like are temporarily written when the CPU 2b performs control operation and from which written data are readout.

Pulse signals (hereinafter, referred to as wheel speed pulses) corresponding to the number of rotations of tires are outputted from the wheel-speed detecting means 1. Based on the wheel speed pulses outputted from the wheel-speed detecting means 1, the rotational angular speed Fi of respective tires is calculated by the CPU 2b at a predetermined sampling cycle ΔT (sec), for example by every ΔT=1 sec.

Since tires are manufactured including variations (initial difference) within specifications, effective rolling radii (value obtained by dividing a proceeded distance with one rotation by 2π) of respective tires are not always the same even if all tires have normal air pressure. Accordingly, the rotational angular speeds Fi of respective tires are uneven. Therefore, there is a method for excluding the influence of initial difference from the rotational angular speeds Fi, for example. According to the method, initial correction coefficients K1, K2 and K3 are calculated as follows:

K1=F1/F2 (1)

K2=F3/F4 (2)

K3=(F1+K1×F2)/(F2+K2×F4) (3)

Subsequently, new rotational angular speeds F1ᵢ are obtained by using the calculated initial correction coefficients K1, K2 and K3 as shown in the following equations (4) to (7):

F1₁=F1 (4)

F1₂=K1×F2 (5)

F1₃=K3×F3 (6)

F1₄=K2×K3×F4 (7)

Herein, the initial correction coefficient K1 is a coefficient for correcting the difference of effective rolling radii caused by the initial difference between the left and right front tires. The initial correction coefficient K2 is a coefficient for correcting the difference of effective rolling radii caused by the initial difference between the left and right rear tires. The initial correction coefficient K3 is a coefficient for correcting the difference of effective rolling radii caused by the initial difference between a left front tire and a left rear tire. The wheel speed Vi of a tire of each of wheels is calculated based on the fore-mentioned F1ᵢ.

In the present Embodiment, vehicle speed (absolute vehicle speed) is estimated (calculated) from the lateral acceleration, yaw rate (speed at which a vehicle is cornering (angular speed)) and roll angle (posture angle) that are generated during cornering of a vehicle by a vehicle-speed estimation device, and then, the simultaneous decreased air pressure of all tires is detected by comparing the estimated vehicle speed with vehicle speed which is calculated from wheel speed (calculated vehicle speed).

For example, when the lateral acceleration which is generated during cornering of a vehicle is referred to as LatAcc, the yaw rate is referred to as w and the vehicle speed is referred to as V, following equation is obtained:

LatAcc=V×ω

Consequently, it is represented as

V=LatAcc/ω (8)

However, both of lateral acceleration sensor and a yaw rate sensor installed on a vehicle for measuring the lateral acceleration and yaw rate cannot accurately measure values because of the influence of roll angle of the vehicle. For example, when the roll angle is referred to as θ, a value measured by the lateral acceleration sensor which is set for measuring the lateral acceleration to a horizontal direction of the vehicle is as follows:

LatAcc′=LatAcc×cos θ (9)

However, when roll is generated to a vehicle, the lateral acceleration sensor is influenced by gravity acceleration; therefore when the gravity acceleration is referred to as g, a value detected by the lateral acceleration sensor is represented as follows:

LatAcc′=LatAcc×cos θ+g×sin θ (10)

At the same time, the value measured by a yaw rate sensor provided to measure the yaw rate of a vehicle is influenced only by the roll angle θ of the vehicle, and represented as follows:

ω′=ω×cos θ (11)

Accordingly, when the fore-mentioned formulae (8), (9) and (11) are converted, the vehicle speed V can be obtained from the following equation (12):

V=(LatAcc′−g×sin θ)/ω′(12)

The roll angle θ can be detected by a suspension height sensor (not illustrated) which is the detecting means for the suspension height. When the suspension height change at the outside of cornering is referred to as d, the inside of cornering is floated by d. Consequently, when the tread width of a vehicle is referred to as Tw, 0 is represented as follows:

θ=tan⁻¹(2d/Tw) (13)

The roll angle can be also detected by using a wheel load sensor or a roll angle sensor which is the roll angle detecting means.

Hereat, in the case a device for preventing roll during cornering is provided, the roll angle θ can be determined as approximately zero.

Accordingly, the vehicle speed can be determined without wheel speed, when the values of the lateral acceleration sensor, the value of the yaw rate sensor and for example, the suspension height change or the value of the lateral acceleration sensor and the value of the yaw rate sensor are obtained.

Accordingly, the device for detecting decreased tire pressure according to the present Embodiment is composed of a wheel-speed detecting means, storage means, lateral acceleration detecting means, yaw rate detecting means, roll angle detecting means, speed estimation and calculation means, comparison means for comparing the calculated vehicle speed with the absolute vehicle speed, and pressure-decrease determination means for determining decreased tire pressure based on the comparison result. As for the above-mentioned comparison, for example, a method of comparing difference or proportion with a predetermined threshold can be used.

Further, the vehicle speed estimating program according to the present Embodiment functionalizes the control unit 2 as speed estimation and calculation means, and the determination program of the decreased tire pressure functionalizes the control unit 2 as the storage means, speed estimation and calculation means, comparison means, and pressure-decrease determination means.

Further, the vehicle-speed estimation device of the present invention is not applied by limiting to the method and the device for detecting decreased tire pressure, but can be also applied to a vehicle operation control method and a device thereof such as the antilock brake control method and device for braking while controlling the wheel speeds to a predetermined slip ratio relative to the vehicle speed.

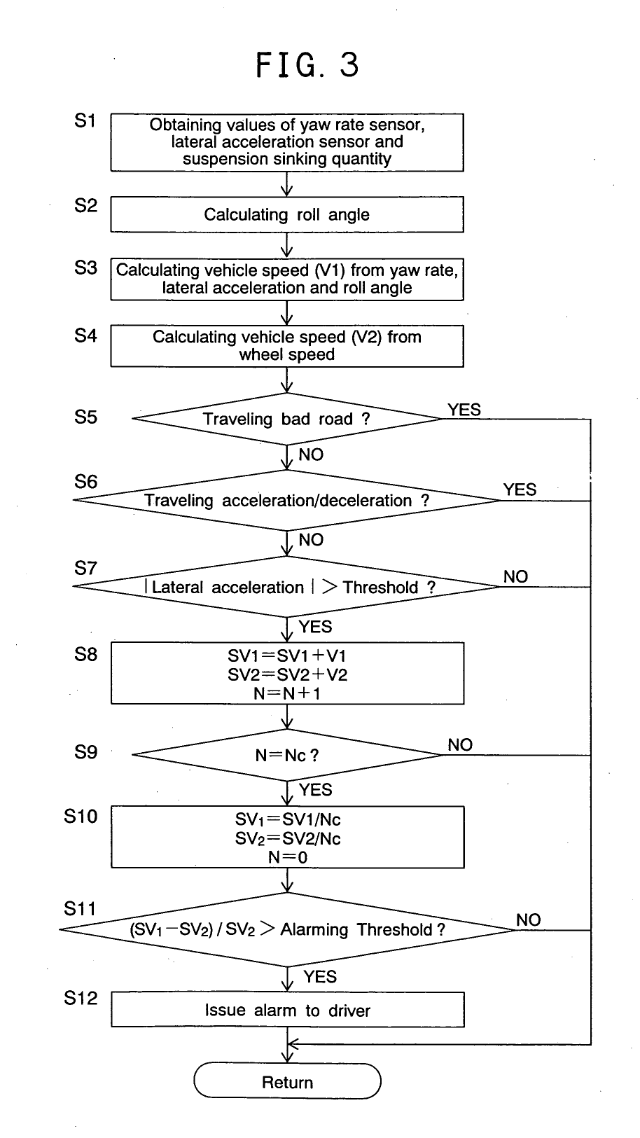

The procedures (1) to (11) of operation of the device for detecting decreased tire pressure according to the present Embodiment are illustrated below based on FIG. 3.

(1) Signals obtained from the lateral acceleration sensor, yaw rate sensor and suspension height sensor which are provided on a vehicle are calculated and the value of the lateral acceleration sensor (lateral acceleration), the value of the yaw rate sensor (yaw rate) and the suspension height change are acquired (Step S1).

(2) When the suspension height change is referred to as d, the roll angle is calculated from formula (13) (Step S2).

(3) The lateral acceleration, yaw rate and roll angle which are determined from Steps S1 and S2 are substituted in formula (12) to calculate the vehicle speed V1 (hereinafter, referred to as absolute vehicle speed) (Step S3).

(4) Then, the vehicle speed V2 (hereinafter, referred to as the calculated vehicle speed) is calculated from the wheel speeds (Step S4). The calculated vehicle speed V2 is obtained by taking an average of the wheel speeds of all tires. With respect to the wheel speeds, the rotational angular speeds Fi of respective tires are firstly calculated based on the wheel speed data of respective tires FL, FR, RL and RR of a vehicle at a certain time obtained by a sensor such as an ABS sensor. Then, after initial correction is made for the rotational angular speeds Fi in order to eliminate the influence of initial difference from the calculated rotational angular speeds Fi as shown in the formulae (4) to (7), the wheel speeds V1ₙ, V2ₙ, V3ₙ and V4ₙ (=r×F1i) can be calculated. It should be noted that r is a constant corresponding to the effective rolling radii at linear traveling.

(5) Then, it is determined whether a vehicle is traveling on a bad road or not. In the case a vehicle is not traveling on a bad road, the procedure proceeds to Step S6, and in the case a vehicle is traveling on a bad road, the rejection process of the wheel speeds V lᵢ (i=1 to 4) is carried out (Step S5).

It should be noted that the bad road is a condition such as a split μ road or a pebble road. When a vehicle travels on a road whose one side is slippery, the wheel speeds V1ᵢ (i=1 to 4) fluctuate even if inner pressure is normal. The split μ road is a road surface on which the frictional coefficient μ is different for left and right tires, and for example, the right side of the road surface is asphalt and the left side of the road surface is grass. Consequently, when the fluctuation of the slip rates for left tire and right tire of a vehicle which is obtained from wheel speed V lᵢ is large, it is determined that a vehicle is traveling on a bad road, and data in such condition is rejected.

(6) Then, it is determined whether the vehicle is traveling in acceleration/deceleration or not. When the vehicle is not traveling in acceleration/deceleration, the procedure proceeds to Step S7. When it is traveling in acceleration/deceleration, the rejection process of the wheel speeds V1₁ (i=1 to 4) is carried out (Step S5).

When a vehicle is traveling in acceleration and deceleration, in other words, acceleration to front and rear direction in traveling is relatively large, it can be considered, for example, that there is the influence of tire slip or foot brake by the abrupt acceleration/abrupt deceleration of the vehicle. When a vehicle is traveling in such condition, tires run idle and there is a higher probability that error is included in the wheel speeds V1ᵢ; therefore the data are rejected at this time. For example, the acceleration to front and rear direction FRAi of each of tires are calculated from the following formula (14), when the wheel speed of respective tires calculated at sampling time prior to the sampling cycle ΔT (sec) is referred to as BV 1ᵢ.

FRAi=(V1ᵢ−BV1ᵢ)/(ΔT×9.8) (14)

When the calculated value corresponds to the following formula (15), the wheel speeds V1ᵢ are rejected.

MAX{|FRAᵢ|}>Ath (for example, Ath=0.1g; g=9.8 (m/sec²)) (15)

(7) Then, it is determined whether the absolute value of the lateral acceleration exceeds a predetermined threshold.

Since the method estimates the vehicle speed by the measured value of lateral acceleration obtained from a lateral acceleration sensor and the value of lateral acceleration which is obtained based on the value of yaw rate obtained from a yaw rate sensor, adequate accuracy can be obtained in the case there is a certain degree of the lateral acceleration. Consequently, when the lateral acceleration of the vehicle exceeds a threshold by comparing the lateral acceleration of the vehicle with the predetermined threshold, the procedure proceeds to Step S8, and when the lateral acceleration of the vehicle does not exceed the threshold, the data at this time are rejected (Step S7).

In other words, with respect to the lateral acceleration of the vehicle, a cornering radius R is calculated from the wheel speeds V1₁ and V1₂ of following wheels FL and FR.

R={(V1₂+V1₁)/(V1₂−V1₁)}×Tw/2

Wherein Tw is a distance (tread width) (m) between king pins.

Then, the lateral acceleration of the vehicle is calculated from the following formula (16) based on the cornering radius R of the vehicle.

Lateral acceleration=V²/R (16)

In the case the value does not correspond to the following formula (17), the wheel speeds V1ᵢ is rejected.

|Lateral acceleration|>threshold Gth (for example, Gth=1 m/sec²) (17)

(8) Then, the absolute vehicle speed V1 and the calculated vehicle speed V2 are added to SV1 and SV2 which are the integrated values of the absolute vehicle speed V1 and the calculated vehicle speed V2 obtained in the previous cycle, and new integrated values (SV1+V1, SV2+V2) are obtained (Step S8). Further, number of calculation times N of a counter provided for measuring time is incremented.

(9) Then, it is determined whether the number of calculation times N of a counter has reached predetermined times Nc or not. In the case the number of calculation times N reaches the predetermined times Nc, the procedure proceeds to Step S10, and in the case the number of calculation times N has not reached the predetermined times Nc, the fore-mentioned procedure is repeated (Step S9).

(10) Then, the averaging process of the integrated values SV1 and SV2 of the absolute vehicle speed and calculated vehicle speed of the fixed times Nc is performed (Step S10). At this time, the number of calculation times N of a counter is cleared.

(11) Then, it is determined whether the ratio of the averaged absolute vehicle speed SV₁ and calculated vehicle speed SV₂ exceeds a predetermined threshold for issuing alarm, for example 0.002 or not. In the case the ratio exceeds the alarming threshold, alarm is issued to a driver to notify the decreased tire pressures, and in the case the ratio does not exceed the alarming threshold, the procedure hitherto is repeated (Steps S11 and S12).

The aspect of present invention will now be illustrated based on Examples, but the present invention is not limited only to such Examples.

### Example 1

A front drive car of 2400 cc on which normal tires LM701 (Sumitomo Rubber Industries, Ltd.: tire size=215/55R16) were loaded was prepared. Then, the judgment program of decreased tire pressure related to the present Embodiment was installed. Then, after all tires were set at normal air pressure (220 kPa), the car runs on a test course which is an oval track and has no bank, and initialization (a step of storing condition in which the air pressures of tires are normal in the system) was carried out. Then, after terminating the initialized traveling, the air pressures of all tires were set at reduced pressure of 110 kPa, and the car runs around the fore-mentioned test course to carry out detection experiments (Example). Further, similar detection experiment was carried out by a conventional reduced pressure judging method (a method of determining using the relative comparison of the vehicle speed on one pair of diagonal lines) (Comparative Example). As a result, in the present Example, the alarm for decreased pressure was issued at traveling for about 30 minutes from the start of detection experiment, but the decreased pressure was not detected in Comparative Example. Thus, it was grasped in the present Example that the simultaneous decrease of air pressure of all tires can be detected.

### Embodiment 2

Another Embodiment of the present invention will now be illustrated. The device for detecting decreased tire pressure related to Embodiment 2 is shown by the compositions of FIGS. 1 and 2 in the similar manner as Embodiment 1. Method and means for detecting the vehicle speed, lateral acceleration and yaw rate are similar as Embodiment 1. However, since the roll angle is not used, the acquisition of the suspension height change is not required.

In Embodiment 2, the decreased tire pressures are detected by using the signals of the lateral acceleration sensors and yaw rate sensors which are loaded on a vehicle.

The signals of a yaw rate sensor are multiplied by the signals of wheel speed sensor to calculate the lateral acceleration. The decreased tire pressure is determined by comparing the calculated lateral acceleration with the signals of the lateral acceleration sensor.

When vehicle speed is V and a turning radius is R, the lateral acceleration is represented by V²/R and the yaw rate is represented by V/R. Accordingly, the vehicle speed V can be calculated by lateral acceleration/yaw rate. Relation (the primary coefficient of a linear regression) between the vehicle speed calculated from the lateral acceleration and yaw rate at normal air pressure and the wheel speed is determined, and when it is shown that the wheel speed is increased by exceeding a predetermined threshold from the change of the relation (primary coefficient), it is determined that the pressure of a tire is decreased. In this case, the simultaneous decreased pressures of four wheels can be also detected.

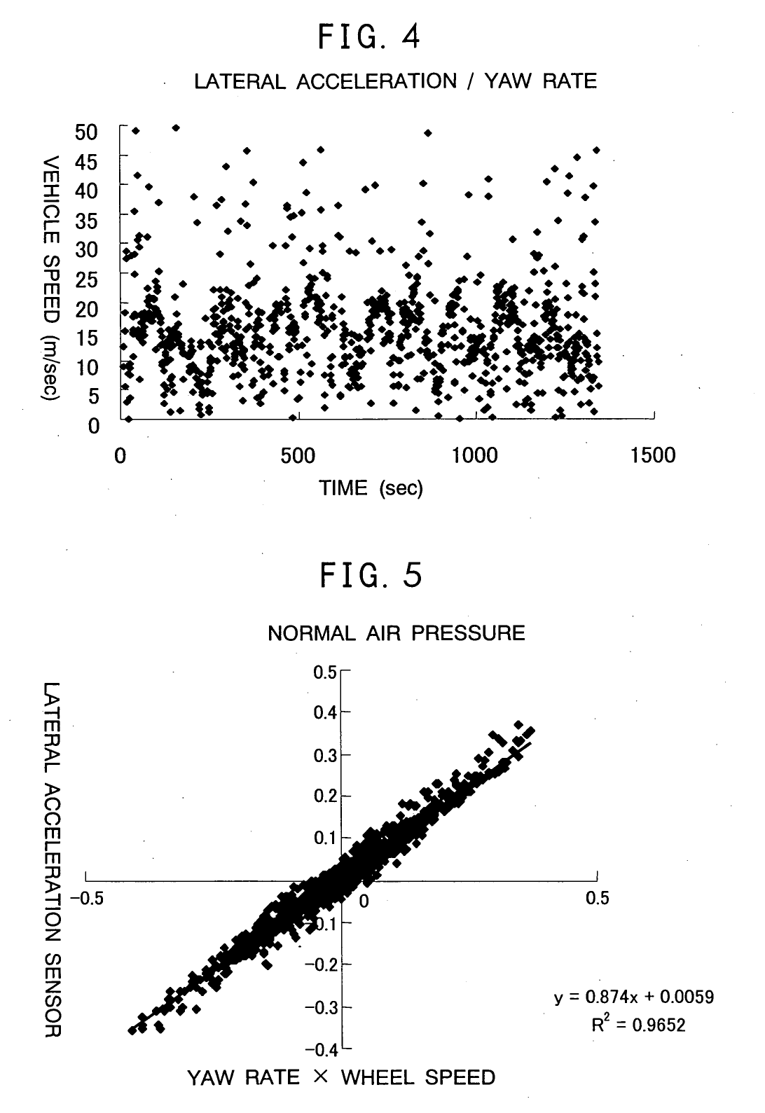

On the other hand, there is such as temperature drift in the lateral acceleration sensor and yaw rate sensor, and in particular, it has been known that accuracy is not so good nearby a zero point. In fact, the vehicle speed which is determined by dividing the lateral acceleration by the yaw rate greatly fluctuates (refer to FIG. 4). Accordingly, in order to use the larger portion of sensor signals considered to be relatively high accuracy, the range of signals of lateral acceleration (or yaw rate) is taken greatly to a certain degree (for example, 0.05 G or more). The lateral acceleration is obtained by multiplying the signals of a yaw rate sensor with the wheel speed, and the calculated value is compared with the signals of lateral acceleration sensor. On the contrary, the signals of the lateral acceleration sensor are divided by the wheel speed to determine a yaw rate, and the calculated value may be compared with the signals of a yaw rate sensor.

For example, when the signals of a lateral acceleration sensor is set as a longitudinal axis and the signals of a yaw rate sensor×the wheel speed is set as a lateral axis to obtain linear regression, the slope (primary coefficient) of the linear regression represents a ratio (vehicle speed/wheel speed) of the vehicle speed to the wheel speed. When the primary coefficients are compared before and after decreased pressure, the primary coefficient becomes smaller for a tire with decreased pressure (the wheel speed becomes faster).

In the case the primary coefficient of a linear regression of the signals of the lateral acceleration sensor to the signals of a yaw rate sensor×the wheel speed is less than a predetermined threshold, it can be determined that the pressure of tires is decreased. Thereby, the decreased pressure of up to four wheels can be detected.

### Comparative Example

FIG. 4 is a graph that a value obtained by dividing the signals of lateral acceleration by the signals of yaw rate is simply plotted as the vehicle speed relative to lapse time. In Comparative Example, POLO manufactured by Volkswagen AG was used as a vehicle, and the vehicle run on a general road with relatively many curves in Germany to be recorded. The vehicle speed obtained by dividing the signals of the lateral acceleration by the signals of the yaw rate fluctuates greater than the actual vehicle speed. The graph of FIG. 4 is plotted by every second, and it is clear in common-sense terms that the actual speed does not fluctuate as shown in FIG. 4.

FIG. 5 is a graph that lateral acceleration calculated from yaw rate (the signals of a yaw rate sensor×wheel speed) and the signals of the lateral acceleration sensor are plotted when tire pressures are normal. A primary coefficient having high correlation is obtained when the linear regression is determined. The primary coefficient at this case was 0.874. Hereat, the wheel speed is the average of rotational speeds of respective wheels.

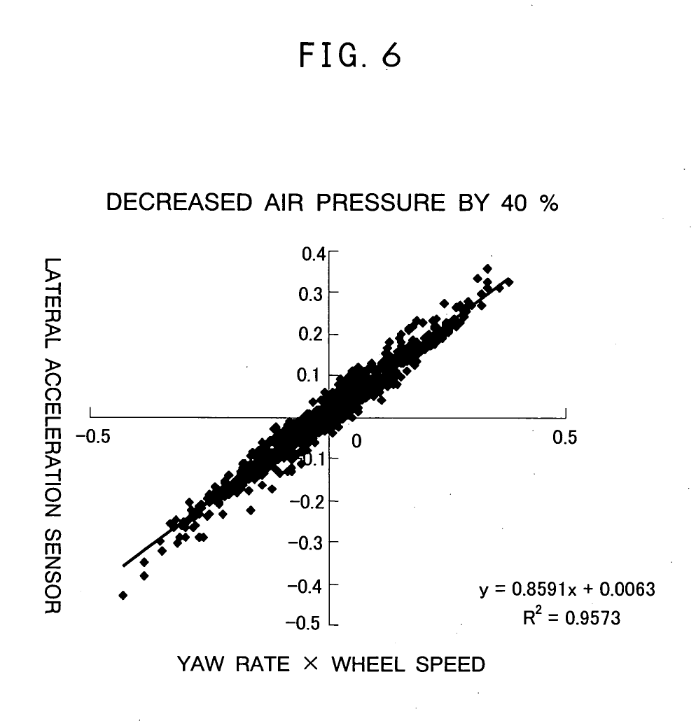

FIG. 6 is a graph that lateral acceleration calculated from yaw rate (the signals of a yaw rate sensor×wheel speed) and the value of the lateral acceleration sensor are plotted when the air pressures of four tires are decreased by 40% for the same vehicle. Similarly, the primary coefficient of the linear regression was 0.8591.

When the primary coefficient of FIG. 5 is compared with that of FIG. 6, the primary coefficient is 0.874 when the tire pressures are normal and 0.8591 when the air pressures of four tires are decreased by 40%, and the primary coefficient is smaller for a case of decreased pressure. Consequently, for example, when the primary coefficient is 0.86 or less, it can be determined that tire pressure is decreased.

According to the present invention, the simultaneous pressure decrease in four wheels can be determined by conventional sensors (which have been already prevailed) such as lateral acceleration sensor, a yaw rate sensor and vehicle speed sensor, and the decreased pressure can be accurately alarmed to a driver.

Further, the method for detecting decreased tire pressure of the present invention does not have limitation in terms of a driving system of a four-wheel vehicle, but can be applied to either of an FF vehicle, FR vehicle, MR vehicle and 4WD vehicle. Further, it is not limited to a four-wheel vehicle, and can be also applied to such as a three wheels vehicle or six wheels vehicle.

What is claimed is:

1. A vehicle-speed estimation device comprising: lateral acceleration detecting means for detecting lateral acceleration of a vehicle; yaw rate detecting means for detecting a yaw rate of the vehicle; roll angle detecting means for detecting a roll angle of the vehicle; and speed estimation and calculation means for estimating vehicle speed from the lateral acceleration, yaw rate and roll angle.

2. A vehicle-speed estimation device comprising: lateral acceleration detecting means for detecting lateral acceleration of a vehicle; yaw rate detecting means for detecting a yaw rate of the vehicle; and speed estimation and calculation means for estimating vehicle speed from the lateral acceleration and yaw rate.

3. A program for estimating vehicle speed of a vehicle, which allows a computer to function as speed estimation and calculation means for estimating the vehicle speed from lateral acceleration, yaw rate and roll angle.

4. A program for estimating vehicle speed of a vehicle, which allows a computer to function as speed estimation and calculation means for estimating the vehicle speed from lateral acceleration and yaw rate.

5. A method for detecting decreased tire pressure on a basis of wheel speed obtained from a tire mounted on a vehicle, the method comprising steps of: detecting wheel speed of each tire; storing vehicle speed calculated from the wheel speed; detecting lateral acceleration of the vehicle; detecting a yaw rate of the vehicle; detecting a roll angle of the vehicle; estimating vehicle speed from the lateral acceleration, yaw rate and roll angle; comparing the estimated vehicle speed with the vehicle speed calculated from the wheel speed; and determining decreased tire pressure on the basis of a result of the comparison.

6. A method for detecting decreased tire pressure on a basis of wheel speed obtained from a tire mounted on a vehicle, the method comprising steps of: detecting wheel speed of each tire; storing vehicle speed calculated from the wheel speed; detecting lateral acceleration of the vehicle; detecting a yaw rate of the vehicle; estimating vehicle speed from the lateral acceleration and yaw rate; comparing the estimated vehicle speed with the vehicle speed calculated from the wheel speed; and determining decreased tire pressure on the basis of a result of the comparison.

7. A device for detecting decreased tire pressure on a basis of wheel speed obtained from a tire mounted on a vehicle, the device comprising: wheel-speed detecting means for detecting wheel speed of each tire; storage means for storing vehicle speed calculated from the wheel speed; lateral acceleration detecting means for detecting lateral acceleration of the vehicle; yaw rate detecting means for detecting a yaw rate of the vehicle; roll angle detecting means for detecting a roll angle of the vehicle; speed estimation and calculation means for estimating vehicle speed from the lateral acceleration, yaw rate and roll angle; comparison means for comparing the estimated vehicle speed with the vehicle speed calculated from the wheel speed; and pressure-decrease determination means for determining decreased tire pressure on the basis of a result of the comparison.

8. A device for detecting decreased tire pressure on a basis of wheel speed obtained from a tire mounted on a vehicle, the device comprising: wheel-speed detecting means for detecting wheel speed of each tire; storage means for storing vehicle speed calculated from the wheel speed; lateral acceleration detecting means for detecting lateral acceleration of the vehicle; yaw rate detecting means for detecting a yaw rate of the vehicle; speed estimation and calculation means for estimating vehicle speed from the lateral acceleration and yaw rate; comparison means for comparing the estimated vehicle speed with the vehicle speed calculated from the wheel speed; and pressure-decrease determination means for determining decreased tire pressure on the basis of a result of the comparison.

9. A program for determining decreased tire pressure on a basis of wheel speed obtained from a tire mounted on a vehicle, the program allowing a computer to function as: storage means for storing vehicle speed calculated from the wheel speed; speed estimation and calculation means for estimating vehicle speed from lateral acceleration, a yaw rate and roll angle; comparison means for comparing the estimated vehicle speed with the vehicle speed calculated from the wheel speed; and pressure-decrease determination means for determining decreased tire pressure on the basis of a result of the comparison.

10. A program for determining decreased tire pressure on a basis of wheel speed obtained from a tire mounted on a vehicle, the program allowing a computer to function as: storage means for storing vehicle speed calculated from the wheel speed; speed estimation and calculation means for estimating vehicle speed from lateral acceleration and a yaw rate; comparison means for comparing the estimated vehicle speed with the vehicle speed calculated from the wheel speed; and pressure-decrease determination means for determining decreased tire pressure on the basis of a result of the comparison.

11. A method for determining decreased tire pressure with the use of lateral acceleration sensor, a yaw rate sensor and wheel speed sensor mounted on a vehicle, the method comprising steps of: detecting lateral acceleration by the lateral acceleration sensor; detecting a yaw rate by the yaw rate sensor; detecting wheel speed by the wheel speed sensor; comparing a value obtained by multiplying the yaw rate by the wheel speed with the lateral acceleration; and determining decreased tire pressure on the basis of a result of the comparison.

12. A device for determining decreased tire pressure, comprising: lateral acceleration sensor for detecting lateral acceleration of a vehicle; a yaw rate sensor for detecting a yaw rate of the vehicle; wheel speed sensor for detecting rotational speed of a wheel mounted on the vehicle; comparison means for comparing a value obtained by multiplying the yaw rate by the wheel speed with the lateral acceleration; and pressure-decrease determination means for determining decreased tire pressure on the basis of a result of the comparison.

13. A program for determining decreased tire pressure mounted on a vehicle, the program allowing a computer to function as: means for inputting lateral acceleration of the vehicle from lateral acceleration sensor; means for inputting a yaw rate of the vehicle from a yaw rate sensor; means for inputting wheel speed of the vehicle from wheel speed sensor; comparison means for comparing a value obtained by multiplying the yaw rate by the wheel speed with the lateral acceleration; and pressure-decrease determination means for determining decreased tire pressure on the basis of a result of the comparison.
